(19) United States
(12) Patent Application Publication
(10) Pub. No.: US 2008/0061255 A1
(43) Pub. Date: Mar. 13, 2008

(54) Wafer aligning apparatus of a semiconductor manufacturing device

(76) Inventor: Hae-Gyun Park, Yongin-si (KR)

Correspondence Address: LEE & MORSE, P.C., 3141 FAIRVIEW PARK DRIVE, SUITE 500, FALLS CHURCH, VA, 22042, US

(21) Appl. No.: 11/896,513

(22) Filed: Sep. 4, 2007

(30) Foreign Application Priority Data
Sep. 12, 2006 (KR) 10-2006-0088002

(51) Int. Cl. G01V 8/00; B32B 9/04

(52) U.S. Cl. 250/559.3; 428/446

(57) ABSTRACT

Example embodiments relate to a wafer aligning apparatus and a method thereof. The wafer aligning apparatus may include a first light sensor unit adapted to output light to an edge of a wafer, a second light sensor unit adapted to output light on a marking position of the wafer, and a controller to calculate a wafer aligning value from an edge position value and a marking position value read from the first and the second light sensor units, respectively.

### BACKGROUND OF THE INVENTION

1. Field of the Invention

Example embodiments relate to a wafer aligning apparatus of a semiconductor manufacturing device.

2. Description of Related Art

As semiconductor memory devices become highly integrated, a size of circuit patterns and a space between the circuit patterns may become smaller. However, an exposure failure may be present when the circuit patterns are misaligned (even by a small amount), and therefore, alignment of the wafer may be significant to an exposure process. Accordingly, a wafer aligning apparatus may be needed to prevent and/or reduce misalignments. The wafer aligning apparatus may include a pre-align chuck to rotate the wafer after absorbing and fixing a wafer transferred by a wafer transferring apparatus, a light emitting device, and a light receiving device for reading a flat zone and/or a notch of the wafer absorbed and fixed on the pre-align chuck.

Semiconductor devices may generally be fabricated by sequentially performing a series of processes. For example, the processes may include photolithography, etching, deposition and diffusion on a silicon wafer after a process of processing and polishing a pure silicon wafer.

In order to embody a previously designed circuit pattern on the wafer, the photolithography process may be divided into a coating process, an exposure process and a photolithography process.

The exposure process may reduce the circuit pattern formed on a reticle to the wafer coated with a photo resist film by using an optical system (i.e., a reduction projection lens). Further, a wafer aligning process for aligning the wafer in one direction based on a flat zone and a notch formed on the wafer (or a plurality of wafers) may be processed before the process of the exposure process. A wafer cassette may be conventionally used to load a plurality of wafers within the semiconductor manufacturing device. In the flat zone, in which the circumference thereof may be partially cut in the form of an arc, may be formed on each wafer loaded in the wafer cassette. The flat zone of the wafer should further be aligned before the wafer is provided to a unit process so that a deposition process and/or an etching process may be performed on the same side of the wafer. In particular, a wafer flat-zone aligner may be used as an aligning apparatus to arrange the wafer in a specific direction by using the flat zone formed on the wafer.

The wafer flat-zone aligner may be configured differently in accordance with various manufacturing techniques, e.g., aligning by placing the flat zone of the wafer toward a lower part, or aligning by placing the flat zone of the wafer toward an upper part.

However, a conventional wafer aligning apparatus that may align the wafer using the flat zone or the notch may encounter problems. For example, the flat zone may reduce the number of chips capable of being formed on the wafer, thereby decreasing productivity. Further, transmission of temperature may be distorted at the wafer's cut part because electrostatic (ESC) chucks may be manufactured by the shape of wafer, thereby causing a variation of the process within the wafer. In case of the notch, e.g., forming a groove in one end of wafer, the ESC chuck may be exposed to plasma by a groove part when processing, thereby reducing the expected life span of the ESC chuck.

### SUMMARY OF THE INVENTION

Example embodiments are therefore directed to a wafer aligning apparatus of a semiconductor manufacturing device, which substantially overcomes one or more of the problems due to the limitations and disadvantages of the related art.

It is therefore a feature of an example embodiment to provide a wafer aligning apparatus by forming a wafer as a circle so as to prevent a reduction of chips.

It is therefore another feature of an example embodiment to provide a wafer aligning apparatus so as to extend the expected life span of a wafer chuck by preventing and/or reducing an exposure of plasma to the wafer chuck.

At least one of the above and other features of example embodiments may be to provide a wafer aligning apparatus including a first light sensor unit adapted to read an edge of a wafer, a second light sensor unit adapted to read a marking position of the wafer, and a controller to calculate a wafer aligning value from an edge position value and a marking position value read from the first and the second light sensor units, respectively.

The first light sensor unit may include a first light emitter to apply light to the wafer being rotated on the pre-align chuck, and a first light receiver to read the edge position of the wafer by receiving the light emitted from the first light emitter.

The second light sensor unit may include a second light emitter to apply light to the wafer being rotated on the pre-align chuck, and a second light receiver to read the marking position of the wafer in response of an amount of received light after the light emitted from the second light emitter is reflected from the wafer.

At least one of the above and other features of example embodiments may be to provide a wafer having a wafer aligning region. The wafer aligning region may include a marking zone at an edge of the wafer.

The marking zone may be a bar-code, and may be formed in shape of a prominence.

At least one of the above and other features of example embodiments may be to provide a wafer aligning system. The system may include a wafer including a wafer aligning region and a wafer aligning apparatus. The wafer aligning region may include a marking zone at an edge of the wafer. The wafer aligning apparatus may include a first light sensor unit adapted to read the edge of the wafer, a second light sensor unit adapted to read a marking position of the wafer, and a controller to calculate a wafer aligning value from an edge position value and a marking position value read from the first and the second light sensor units, respectively.

At least one of the above and other features of example embodiments may be to provide a method for aligning a wafer. The method may include transferring the wafer to a pre-align chuck disposed on a main body, reading an edge position of the wafer by applying light to the wafer being rotated on the pre-align chuck by a first light sensor unit, reading a marking position by applying the light to the wafer being rotated on the pre-align chuck by a second light sensor unit, calculating a wafer aligning value from an edge position value and a marking position value read from the first and the second light sensor units, respectively, and sending the calculated values to a controller to control a wafer transferring apparatus.

At least one of the above and other features of example embodiments may be to provide a method of forming a wafer. The method may include providing a wafer aligning region on the wafer, wherein the wafer aligning region may be a marking zone at an edge of the wafer

### BRIEF DESCRIPTION OF THE DRAWINGS

The above and other features and advantages of the example embodiments will become more apparent to those of ordinary skill in the art by describing in detail exemplary embodiments thereof with reference to the attached drawings, in which:

FIG. 1 illustrates a structural view of a wafer aligning apparatus according to an example embodiment;

FIG. 2 illustrates a structural view of a wafer according to an example embodiment; and

FIG. 3 illustrates a flowchart of a method of aligning a wafer according to an example embodiment.

### DETAILED DESCRIPTION OF THE INVENTION

Korean Patent Application No. 10-2006-0088002, filed on Sep. 12, 2006, in the Korean Intellectual Property Office, and entitled: “Wafer Aligning Apparatus of Semiconductor Manufacturing Device,” is incorporated by reference herein in its entirety.

Example embodiments will now be described more fully hereinafter with reference to the accompanying drawings. Example embodiments may, however, be embodied in different forms and should not be construed as limited to the embodiments set forth herein. Rather, these example embodiments are provided so that this disclosure will be thorough and complete, and will fully convey the scope of the invention to those skilled in the art.

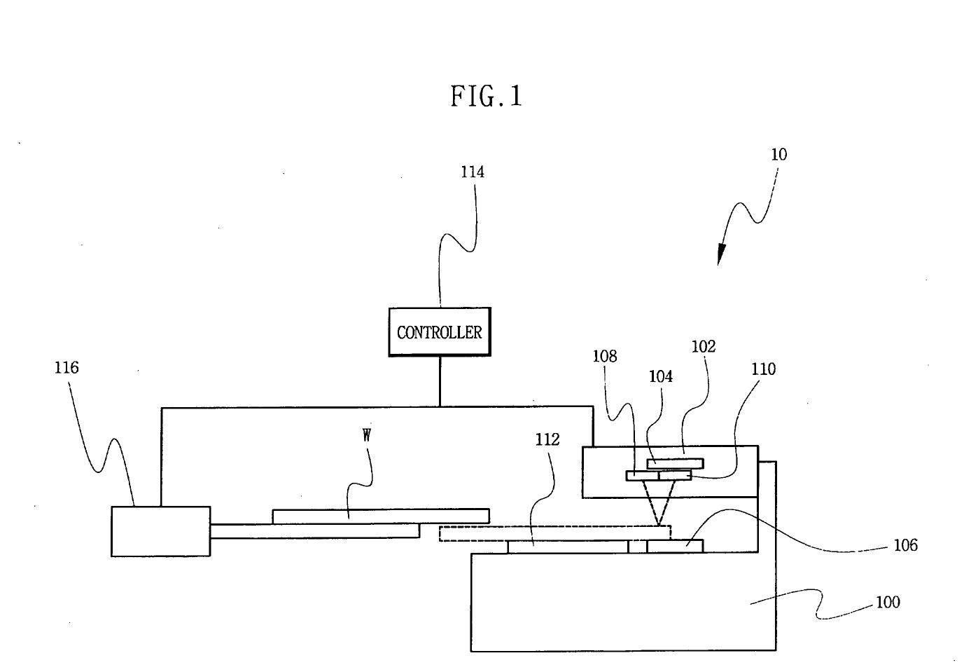

FIG. 1 illustrates a structural view of a wafer aligning apparatus 10 according to an example embodiment.

The apparatus 10 may include a main body 100 for aligning a wafer W, a pre-align chuck 112 disposed on the main body 100 to rotate the wafer W after absorbing and fixing the wafer W, an opto-electronic fixing part 102 disposed on the main body 100 to form an optical electronic, a first light emitter 104 disposed in the opto-electronic fixing part 102 to apply light to wafers being rotated on the pre-align chuck 112, a first light receiver 106 to receive light emitted from the first light emitter 104, a second light emitter 108 to apply light to the wafer W being rotated on the pre-align chuck 112, a second light receiver 110 to receive the light emitted from the second light emitter 108, a controller 114, and a wafer transferring apparatus 116. The first light receiver 106 may read an edge position of the wafer W by receiving light emitted from the first light emitter 104. The second light receiver 110 may read a marking position of the wafer W according to an amount of light received from the second light emitter 108. The controller 114 may calculate a wafer aligning value by receiving the edge position value and the marking position value sensed by the first and the second light receivers 106, 110. The wafer transferring apparatus 116 may then properly transfer the wafer W into an arranged position by receiving the wafer aligning position valve calculated from the controller 114.

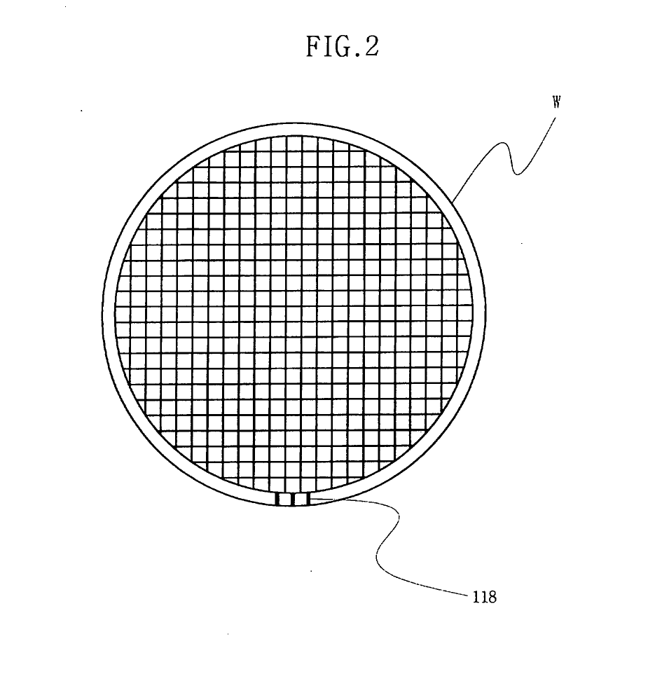

FIG. 2 illustrates a view of a wafer shaped according to an example embodiment.

A marking zone 118 marked by a bar-code, for example, may be disposed at one side of an edge of a circular shaped wafer W. The marking zone 118 may be formed as a prominence (e.g., bump, protrusion, projection, bulge and etc.). It should be appreciated that the wafer W may be configured in other shapes besides a circle.

Referring back to FIG. 1, the wafer W may be transferred to the pre-align chuck 112 disposed on a main body 100 by the wafer transferring apparatus 116. When the wafer W is transferred to the pre-align chuck 112, the controller 114 may absorb the wafer W by a vacuum, for example, and may control the pre-align chuck 112 to rotate the wafer W. Subsequently, the controller 114 may drive the first light emitter 104 and the second light emitter 108, and thus, light may be output to the wafer W being rotated on the pre-align chuck 112. At this time, light output from the first light emitter 104 may be received by the first light receiver 106, and light output from the second light emitter 108 may be reflected by the wafer W and may be received by the second light receiver 110. The first light receiver 106 may receive light output by the first light emitter 104 when there is no wafer W present between the first light emitter 104 and the first light receiver 106.

The light output from the second light emitter 108 may be reflected at the edge of the wafer W, and may become the received light for the second light receiver 110. The second light receiver 110 may read an amount of the received light from areas where a marking zone 118 may exist when the wafer W rotates. In an example embodiment, the marking zone 118 may be a bar-code having a prominence at the edge of the wafer W. The first and the second light receivers 106, 110 may send an amount of the received light to the controller 114. The controller 114 may receive the amount of the received light and may calculate the wafer aligning value. The controller 114 may then send the calculated wafer aligning value to the wafer transferring apparatus 116.

When the wafer rotates, light from the second light emitter 108 may be reflected and may be light detected by the second light receiver 110 at the marking zone 118. At this time, a position value of the marking zone 118 may be detected according to the difference of the amount of received light, since a difference of the amount of the received light may occur at the marking zone 118 and a region outside of the marking zone 118.

Example embodiments illustrate the marking zone 118 in shape of a bar-code shaped prominence, however, it should be appreciated that other methods of reading the marking zone 118 may be embodied. It should further be appreciated that other mechanisms beside the marking zone 118 may be employed to read the amount of received light.

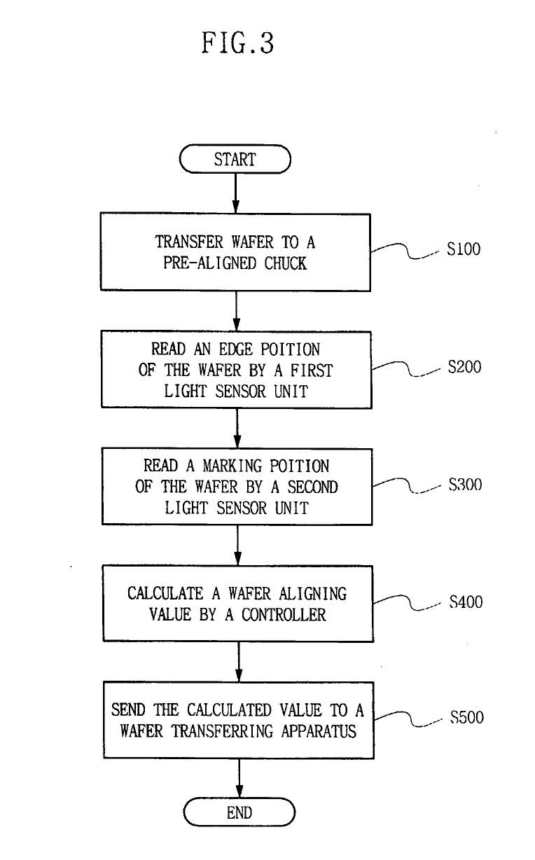

FIG. 3 illustrates a flowchart of a method of aligning a wafer according to an example embodiment.

In S100, the wafer transferring apparatus 116 may transfer the wafer W to the pre-aligned chuck 112 disposed on the main body 100. When the wafer W is transferred to the pre-align chuck 112, the controller 114 may control the pre-align chuck 112 to rotate the wafer W. Further, the controller 114 may drive the first light emitter 104 and the second light emitter 108, and thus, light may be applied to the wafer W being rotated on the pre-align chuck 112. In S200, the first light receiver 106 may receive light output by the first light emitter 104, and may read an edge position of the wafer W rotated on the pre-align chuck 112. Then in S300, the second light receiver 110 may receive light output by the second light emitter 108 and reflected by the wafer W, and may read a marking position of the wafer W. It should be appreciated that the S200 and S300 may be performed simultaneously or in any order.

In S400, the controller 114 may receive the amount of the received light from the first and second light receivers 106 and 110, and may calculate a wafer aligning value. Then in S500, the controller 114 may send the calculated wafer aligning value to the wafer transferring apparatus 116 so as to arrange the wafer W into position.

Example embodiments may extend an expected life span of a wafer chuck by preventing and/or reducing the wafer chuck from being exposed to plasma due to the circular shape of the wafer.

Example embodiments may further provide a wafer with a marking zone formed as a bar-code on an edge of the wafer so as to read an amount of received light.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the example embodiments as set forth in the following claims.

What is claimed is:

1. A wafer aligning apparatus, comprising:
a first light sensor unit adapted to read an edge of a wafer;
a second light sensor unit adapted to read a marking position of the wafer; and
a controller to calculate a wafer aligning value from an edge position value and a marking position value read from the first and the second light sensor units, respectively.

2. The wafer aligning apparatus as claimed in claim 1, wherein the first light sensor unit comprises:
a first light emitter to apply light to the wafer being rotated on a pre-align chuck; and
a first light receiver to read the edge position of the wafer by receiving the light emitted from the first light emitter.

3. The wafer aligning apparatus as claimed in claim 1, wherein the second light sensor unit comprises:
a second light emitter to apply light to the wafer being rotated on a pre-align chuck; and
a second light receiver to read the marking position of the wafer in response to an amount of received light after the light emitted from the second light emitter is reflected from the wafer.

4. The wafer aligning apparatus as claimed in claim 1, further comprising:
a main body for aligning a wafer;
a pre-align chuck disposed on the main body to rotate the wafer; and
an opto-electronic fixing part disposed and fixed on the main body to fix a sensor.

5. A wafer, comprising:
a wafer aligning region, the wafer aligning region including a marking zone at an edge of the wafer.

6. The wafer as claimed in claim 5, wherein the marking zone is a bar-code.

7. The wafer as claimed in claim 6, wherein the marking zone is formed as a shape of a prominence.

8. A wafer aligning system, comprising:
a wafer including a wafer aligning region, the wafer aligning region including a marking zone at an edge of the wafer; and
a wafer aligning apparatus, the wafer aligning apparatus including:
a first light sensor unit adapted to read the edge of the wafer;
a second light sensor unit adapted to read a marking position of the wafer; and
a controller to calculate a wafer aligning value from an edge position value and a marking position value read from the first and the second light sensor units, respectively.

9. The wafer aligning system as claimed in claim 8, wherein the marking position is a bar-code shaped prominence.

10. The wafer aligning system as claimed in claim 8, wherein the first light sensor unit comprises:
a first light emitter to apply the light to the wafer being rotated on a pre-align chuck; and
a first light receiver to read the edge position of the wafer by receiving the light emitted from the first light emitter.

11. The wafer aligning system as claimed in claim 8, wherein the second light sensor unit comprises:
a second light emitter to apply the light to the wafer being rotated on a pre-align chuck; and
a second light receiver to read the marking position of the wafer in response to a received light after the light emitted from the second emitting sensor is reflected from the wafer.

12. The wafer aligning system as claimed in claim 8, wherein the wafer aligning apparatus further comprising:
a main body for aligning a wafer;
a pre-align chuck disposed on the main body to rotate the wafer; and
a sensor fixing part disposed and fixed on the main body to fix a sensor;

13. A method for aligning a wafer, comprising:
transferring the wafer to a pre-align chuck disposed on a main body;
reading an edge position of the wafer by applying light to the wafer being rotated on the pre-align chuck by a first light sensor unit;
reading a marking position by applying the light to the wafer being rotated on the pre-align chuck by a second light sensor unit;
calculating a wafer aligning value from an edge position value and a marking position value read from the first and the second light sensor units, respectively; and
sending the calculated values to a controller to control a wafer transferring apparatus.

14. The method as claimed in claim 13, wherein the first light sensor unit comprises:
a first light emitter to apply the light to the wafer being rotated on the pre-align chuck; and
a first light receiver to read the edge position of the wafer by receiving the light emitted from the first light emitter.

15. The method as claimed in claim 13, wherein the second light sensor unit comprises:
a second light emitter to apply the light to the wafer being rotated on the pre-align chuck; and
a second light receiver to read the marking position of the wafer in response to an amount of received light after the light emitted from the second light emitter is reflected from the wafer.

16. A method of forming a wafer, comprising:
providing a wafer aligning region on the wafer, wherein the wafer aligning region is a marking zone at an edge of the wafer.

17. The method as claimed in claim 16, wherein the marking zone is a bar-code.

18. The method as claimed in claim 17, wherein the marking zone is formed as a shape of a prominence.
